(19) United States
(12) Patent Application Publication
(10) Pub. No.: US 2009/0264330 A1
(43) Pub. Date: Oct. 22, 2009

(54) Cleanser for Hard Surfaces

(75) Inventors: Erik Bruckner, Hilden (DE); Stefan Karsten, Gummersbach (DE); Jurgen Noglich, Dusseldorf (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/991,985

(22) PCT Filed: Sep. 5, 2006
(86) PCT No.: PCT/EP2006/008638

§ 371 Date: Aug. 19, 2008

(30) Foreign Application Priority Data
Sep. 16, 2005 (DE) 102005044513.6

(51) Int. Cl. C11D 17/08; C11D 3/20

(52) U.S. Cl. 510/181; 510/421

(57) ABSTRACT

An aqueous cleaning composition for hard surfaces which is applied to the surface to be cleaned in the form of a foam by means of a spray dispenser comprises a fatty alcohol sulfate and/or a fatty acid sarcosinate, and also isopropanol and butylglycol. The composition can be used in a process for streak-free cleaning of hard surfaces, especially glass. In the course of use as intended for cleaning hard surfaces, the decomposition of the cleaning foam is acoustically perceptible in the form of a crackling noise.

The application provides a cleaning composition for hard surfaces, especially glass, which is applied to the surface to be cleaned in the form of a foam by means of a spray dispenser and comprises fatty alcohol sulfate and/or fatty acid sarcosinate, and also isopropanol and butylglycol. The foam generated on spraying also adheres readily on vertical surfaces, but decomposes rapidly when wiped and with a quiet crackling noise and leaves behind virtually no residues on the clean surface; more particularly, no streak or smear formation is observed.

In the cleaning of hard surfaces, it is always desirable that the cleaning composition, after successful cleaning of the stains, is in turn fully removed and dries off very substantially without residue. Especially on glass surfaces, unsightly streaks and smears otherwise remain, which can be removed only by an increased level of work. Moreover, it is desirable, in the case of vertical surfaces in particular, for example windows or mirrors, that the cleaning composition does not run off immediately after application, but rather remains adhering on the stains for a certain time in order to enable better commencement of dissolution of the soil. This can be brought about, for example, by applying the cleaning composition in the form of a foam. However, this foam should decompose rapidly when subsequently wiped with a cloth, sponge, leather or other suitable substrate, in order to ensure the desired residue-free cleaning.

It was therefore an object of the present invention to provide an aqueous cleaning composition for hard surfaces with good cleaning performance, which firstly forms a stable and readily adhering foam which, secondly, decomposes rapidly when wiped off and leaves behind a very low level of residues when removed.

It has now been found that an aqueous cleaning composition for hard surfaces, especially glass, which is applied to the surface to be cleaned in the form of a foam by means of a spray dispenser and comprises fatty alcohol sulfate and/or fatty acid sarcosinate, and also isopropanol and butylglycol, has a particularly good cleaning performance. On the one hand, the foam formed adheres particularly efficiently on the surface to be cleaned, such that the soil is wetted and partly dissolved for a longer time, but, on the other hand, the foam decomposes rapidly when wiped and can be removed virtually without residue or streaks. At the same time, a crackling noise is audible on decomposition of the foam, which is enhanced in the case of a greater degree of soiling, such that the action of the composition can simultaneously be experienced sensorily by the user.

This invention therefore provides an aqueous cleaning composition for hard surfaces, which is applied to the surface to be cleaned in the form of a foam by means of a spray dispenser, and comprises a fatty alcohol sulfate and/or fatty acid sarcosinate, and also isopropanol and butylglycol.

The foam stability and the runoff rate of the foam on vertical surfaces can surprisingly be improved further by the addition of a colloidal silica sol customary as a hydrophilizing agent, such that a preferred embodiment further comprises this ingredient.

In the context of the present invention, fatty acids, fatty alcohols and derivatives thereof—unless stated otherwise—represent branched or unbranched carboxylic acids, alcohols and derivatives thereof having preferably from 6 to 22 carbon atoms. Being based on renewable raw materials, especially owing to their vegetable basis, the former are preferred for ecological reasons, but without restricting the inventive teaching to them. In particular, the oxo alcohols or derivatives thereof obtainable, for example, by the Roelen oxo synthesis are also usable correspondingly.

Whenever reference is made hereinafter to alkaline earth metals as counterions for monovalent anions, this means that the alkaline earth metal is of course present only in half the amount—sufficient to balance the charge—of the anion.

Substances which also serve as ingredients of cosmetic compositions are referred to hereinafter according to the International Nomenclature Cosmetic Ingredient (INCI) nomenclature. Chemical compounds bear an INCI name in English; vegetable ingredients are named exclusively according to Linné in Latin. So-called trivial names such as “water”, “honey” or “sea salt” are likewise specified in Latin. The INCI names can be taken from the “International Cosmetic Ingredient Dictionary and Handbook, Seventh Edition (1997)”, which is published by The Cosmetic, Toiletry and Fragrance Association (CTFA), 1101, 17th Street, NW, Suite 300, Washington, D.C. 20036, U.S.A., and contains more than 9000 INCI names and references to more than 37 000 trade names and technical designations including the accompanying distributors from more than 31 countries. The International Cosmetic Ingredient Dictionary and Handbook assigns to the ingredients one or more chemical classes, for example “Polymeric Ethers”, and one or more functions, for example “Surfactants-Cleansing Agents”, which in turn illustrates it in detail. Reference may likewise be made hereinafter to these.

The label “CAS” means that the numerical sequence which follows is a designation of the Chemical Abstracts Service.

Unless explicitly stated otherwise, amounts specified in percent by weight (% by weight) are based on the overall composition. These percentages are based on active contents.

### Fatty Alcohol Sulfates

Preferred alkyl sulfates (fatty alcohol sulfates, FAS) are the alkali metal salts and especially the sodium salts of the sulfuric monoesters of the C₁₂₋₁₈ fatty alcohols, for example of coconut fatty alcohol, tallow fatty alcohol, lauryl alcohol, myristyl alcohol, cetyl alcohol or stearyl alcohol, or of the C₁₀₋₂₀-oxo alcohols and those monoesters of secondary alcohols of these chain lengths. Preference is further given to alkyl sulfates of the chain length mentioned which contain a synthetic straight-chain alkyl radical which is prepared on a petrochemical basis and have analogous degradation behavior to the equivalent compounds based on fatty chemical raw materials. Particular preference is given to the C₁₀-C₁₆-alkyl sulfates, especially the C₁₂-C₁₄-alkyl sulfates. In addition, it is also possible to use alkyl sulfates with singly or multiply branched alkyl chains or cyclic alkyl radicals.

The fatty alcohol sulfates are typically used in the form of the alkali metal, alkaline earth metal and/or mono-, di- or trialkanolammonium salt, and/or or else in the form of their corresponding acid to be neutralized in situ with the appropriate alkali metal hydroxide, alkaline earth metal hydroxide and/or mono-, di- or trialkanolamine. Preferred alkali metals in this context are potassium and especially sodium, preferred alkaline earth metals are calcium and especially magnesium, and preferred alkanolamines are mono-, di- or triethanolamine.

Fatty alcohol sulfates used with preference are in particular sodium laurylsulfate or monoethanolamine laurylsulfate, for example the corresponding Texapon® types which are supplied by Cognis. Particular preference is given to monoethanolamine laurylsulfate. A further preferred raw material is the mixture of sodium laurylsulfate and 1-octyl-2-pyrrolidone which is supplied under the trade name EasyWet™ 20 by ISP.

According to the invention, fatty alcohol sulfates are used in amounts of from 0.01 to 1% by weight, preferably from 0.02 to 0.5% by weight.

### Fatty Acid Sarcosinates

Alternatively or additionally to the fatty alcohol sulfate, the composition may also comprise one or more fatty acid sarcosinates (alkyl methylglycinates). These are the salts of the condensation products of fatty acids with N-methylglycine (sarcosine) of the general formula R—CO—N(CH₃)—CH₂—COOH in which R is a straight-chain C₇-C₂₁-alkyl radical.

These too are typically used in the form of the alkali metal, alkaline earth metal and/or mono-, di- or trialkanolammonium salt and/or else in the form of their corresponding acids to be neutralized in situ with the appropriate alkali metal hydroxide, alkaline earth metal hydroxide and/or mono-, di- or trialkanolamine; preference is given especially to the sodium salts. Particularly preferred fatty acid sarcosinates are sodium C₁₂-C₁₈-sarcosinate (INCI Sodium Cocoyl Sarcosinate), which can be purchased, for example, under the trade name Perlastan® C-30 from Schill & Seilacher, and sodium lauroylsarcosinate, which is commercially available, for example, under the trade name Medialan® LD30 from Clariant.

According to the invention, fatty acid sarcosinates are used in amounts of from 0.01 to 0.5% by weight.

### Solvent

The inventive composition comprises the solvents isopropanol (INCI Isopropyl Alcohol) and butylglycol (INCI Butoxy Ethanol, Ethylene Glycol Butyl Ether). In addition, one or more further water-soluble organic solvents may be present, among which diethylene glycol is particularly preferred.

Suitable solvents are, for example, saturated or unsaturated, preferably saturated, branched or unbranched C₁₋₂₀-hydrocarbons, preferably C₂₋₁₅-hydrocarbons, with at least one hydroxyl group and optionally one or more ether functions C—O—C, i.e. oxygen atoms which interrupt the carbon atom chain.

Preferred solvents are the C₂₋₆-alkylene glycols and poly-C₂₋₃-alkylene glycol ethers—optionally etherified on one side with a C₁₋₆-alkanol with an average of from 1 to 9 identical or different, preferably identical, alkylene glycol groups per molecule, and also the C₁₋₆-alcohols, preferably ethanol, n-propanol or n-butanol, especially ethanol.

Examples of solvents are the following compound names according to INCI: Alcohol (Ethanol), Buteth-3, Butoxydiglycol, Butoxyisopropanol, Butoxypropanol, n-Butyl Alcohol, t-Butyl Alcohol, Butylene Glycol, Butyloctanol, Diethylene Glycol, Dimethoxydiglycol, Dimethyl Ether, Dipropylene Glycol, Ethoxydiglycol, Ethoxyethanol, Ethyl Hexanediol, Glycol, Hexanediol, 1,2,6-Hexanetriol, Hexyl Alcohol, Hexylene Glycol, Isobutoxypropanol, Isopentyldiol, 3-Methoxybutanol, Methoxydiglycol, Methoxyethanol, Methoxyisopropanol, Methoxymethylbutanol, Methoxy PEG-10, Methylal, Methyl Alcohol, Methyl Hexyl Ether, Methylpropanediol, Neopentyl Glycol, PEG-4, PEG-6, PEG-7, PEG-8, PEG-9, PEG-6 Methyl Ether, Pentylene Glycol, PPG-7, PPG-2-Buteth-3, PPG-2 Butyl Ether, PPG-3 Butyl Ether, PPG-2 Methyl Ether, PPG-3 Methyl Ether, PPG-2 Propyl Ether, Propanediol, Propyl Alcohol (n-Propanol), Propylene Glycol, Propylene Glycol Butyl Ether, Propylene Glycol Propyl Ether, Tetrahydrofurfuryl Alcohol, Trimethylhexanol.

Particularly preferred solvents are the poly-C₂₋₃-alkylene glycol ethers which have been etherified on one side with a C₁₋₆-alkanol and have an average of from 1 to 9, preferably from 2 to 3, ethylene glycol or propylene glycol groups, for example PPG-2 Methyl Ether (dipropylene glycol monomethyl ether).

The inventive composition comprises isopropanol preferably in amounts of from 0.01 to 5% by weight, preferably from 0.1 to 3% by weight, and butylglycol preferably in amounts of from 0.1 to 6% by weight, preferably from 1 to 5% by weight.

In a preferred embodiment, from 0.01 to 0.5% by weight, preferably from 0.025 to 0.1% by weight, of diethylene glycol is additionally present. Further particularly preferred organic solvents are preferably selected from the group comprising C₁₋₆-alcohols, C₂₋₆-diols and mixtures thereof, especially selected from the group comprising ethanol, n-butanol, ethylene glycol, diethylene glycol, propylene glycol and mixtures thereof.

In addition to those mentioned above, the inventive composition may comprise further ingredients. These include especially compositions for modifying or hydrophilizing surfaces, pH modifiers, surfactants, preservatives, corrosion inhibitors, dyes, fragrances, bleaches, enzymes, thickeners, disinfectants, electrolyte salts, UV stabilizers and mixtures thereof. Compositions for Hydrophilizing Surfaces

Suitable substances for hydrophilization are especially colloidal silica sols in which the silicon dioxide is preferably present in nanoparticulate form. Colloidal nanoparticulate silica sols in the context of this invention are stable dispersions of amorphous particulate silicon dioxide SiO₂ with particle sizes in the range from 1 to 100 nm. The particle sizes are preferably in the range from 3 to 50 nm, more preferably from 4 to 40 nm. One example of a silica sol which is suitable for use in the context of this invention is the silica sol which is obtainable under the trade name Bindzil® 30/360 from Akzo and has a particle size of 9 nm. Further suitable silica sols are Bindzil® 15/500, 30/220, 40/200 (Akzo), Nyacol® 215, 830, 1430, 2034DI and Nyacol® DP5820, DP5480, DP5540 etc. (Nyacol Products), Levasil® 100/130, 100F/30, 100S/30, 200/30, 200F/30, 300F/30, VP 4038, VP 4055 (H.C. Starck/Bayer) or else CAB-O-SPERSE® PG 001, PG 002 (aqueous dispersions of CAB-O-SIL®, Cabot), Quartron PL-1, PL-3 (FusoChemical Co.), Köstrosol 0830, 1030, 1430 (Chemiewerk Bad Köstritz). The silica sols used may also be surface-modified silica which has been treated with sodium aluminate (alumina-modified silica).

In addition, it is also possible to use certain polymers for hydrophilization of surfaces. Suitable hydrophilizing polymers are especially amphoteric polymers, for example copolymers of acrylic acid or methacrylic acid and MAPTAC, DADMAC or another polymerizable quaternary ammonium compound. In addition, it is also possible to use copolymers with AMPS (2-acrylamido-2-methylpropanesulfonic acid). Polyether siloxanes, i.e. copolymers of polymethylsiloxanes with ethylene oxide or propylene oxide segments are further suitable polymers. It is likewise possible to use acrylic polymers, maleic acid copolymers and polyurethanes with PEG (polyethylene glycol) units.

Suitable polymers are, for example, commercially available under the trade names Mirapol Surf-S 100, 110, 200, 210, 400, 410, A 300, A 400 (Rhodia), Tegopren 5843 (Goldschmidt), Sokalan CP 9 (BASF) or Polyquart Ampho 149 (Cognis).

However, particular preference is given to using the colloidal silica sol obtainable under the trade name Bindzil® 30/360, preferably in amounts of from 0.01 to 0.6% by weight.

### Volatile Alkali; Bases

In addition, the inventive compositions may comprise volatile alkali. The volatile alkalis used are ammonia and/or alkanolamines which may contain up to 9 carbon atoms in the molecule. Preferred alkanolamines are the ethanolamines, and, among these, monoethanolamine is preferred in turn. The content of ammonia and/or alkanolamine is preferably from 0.01 to 0.5% by weight; particular preference is given to using ammonia.

In addition, the inventive cleaning compositions, in particular formulations with an acidic pH, may also comprise small amounts of bases. Preferred bases stem from the group of the alkali metal hydroxides and carbonates and alkaline earth metal hydroxides and carbonates, especially of the alkali metal hydroxides, among which potassium hydroxide and in particular sodium hydroxides are particularly preferred. In the acidic compositions, bases are used in amounts of not more than 1% by weight, preferably from 0.01 to 0.1% by weight.

### Acids

Alkaline compositions may, as well as the volatile alkali, additionally comprise carboxylic acid, where the equivalents ratio of amine and/or ammonia to carboxylic acid is preferably between 1:0.9 and 1:0.1. Suitable carboxylic acids are those having up to 6 carbon atoms, which may be mono-, di- or polycarboxylic acids. According to the equivalent weight of amine and carboxylic acid, the content of carboxylic acid is preferably between 0.01 and 2.7% by weight, especially between 0.01 and 0.9% by weight. Examples of suitable carboxylic acids are acetic acid, glycolic acid, lactic acid, citric acid, succinic acid, adipic acid, malic acid, tartaric acid and gluconic acid, among which preference is given to using acetic acid, citric acid and lactic acid. Particular preference is given to using acetic acid.

The inventive acidic cleaning compositions may also comprise acids instead of volatile alkali. Suitable acids are especially organic acids such as the carboxylic acids already mentioned: acetic acid, citric acid, glycolic acid, lactic acid, succinic acid, adipic acid, malic acid, tartaric acid and gluconic acid or else amidosulfonic acid. In addition, it is, though, also possible to use the mineral acids hydrochloric acid, sulfuric acid and nitric acid or mixtures thereof. Particular preference is given to using acids selected from the group comprising amidosulfonic acid, citric acid and formic acid. They are used preferably in amounts of from 0.1 to 5% by weight, more preferably from 0.5 to 4% by weight, especially from 1 to 3% by weight.

### Further Surfactants

The inventive composition may, as well as the fatty alcohol sulfates mentioned, also comprise further surface-active substances (surfactants), especially from the classes of the anionic and nonionic surfactants.

Suitable anionic surfactants are preferably C₈-C₁₈-alkylbenzenesulfonates, especially with about 12 carbon atoms in the alkyl moiety, C₈-C₂₀-alkanesulfonates, C₈-C₁₈-alkyl polyglycol ether sulfates (fatty alcohol ether sulfates) having from 2 to 10 ethylene oxide (EO) and/or propylene oxide (PO) units in the ether moiety, and also sulfosuccinic acid mono- and di-C₈-C₁₈-alkyl esters. In addition, it is also possible to use C₈-C₁₈-α-olefinsulfonates, sulfonated C₈-C₁₈ fatty acids, especially dodecylbenzenesulfonate, C₈-C₂₂-carboxamide ether sulfates, C₈-C₁₈-alkyl polyglycol ether carboxylates, C₈-C₁₈-N-acyltaurides and C₈-C₁₈-alkyl isethionates or mixtures thereof.

The anionic surfactants are preferably used in the form of the sodium salts, but may also be present in the form of other alkali metal or alkaline earth metal salts, for example magnesium salts, and also in the form of ammonium salts or mono-, di-, tri- or tetraalkylammonium salts, and in the case of the sulfonates also in the form of their corresponding acid, for example dodecylbenzenesulfonic acid.

Examples of such surfactants are sodium lauryl ether sulfate with 2 EO, sodium sec-alkanesulfonate with approx. 15 carbon atoms or else sodium dioctylsulfosuccinate.

Nonionic surfactants which should be mentioned are in particular C₈-C₁₈-alcohol polyglycol ethers, i.e. ethoxylated and/or propoxylated alcohols having from 8 to 18 carbon atoms in the alkyl moiety and from 2 to 15 ethylene oxide (EO) and/or propylene oxide units (PO), C₈-C₁₈-carboxylic acid polyglycol esters with 2 to 15 EO, for example tallow fatty acid+6 EO esters, ethoxylated fatty acid amides having from 12 to 18 carbon atoms in the fatty acid moiety and from 2 to 8 EO, long-chain amine oxides having from 14 to 20 carbon atoms and long-chain alkylpolyglycosides having from 8 to 14 carbon atoms in the alkyl moiety and from 1 to 3 glycoside units. Examples of such surfactants are oleyl-cetyl alcohol with 5 EO, nonylphenol with 10 EO, lauric diethanolamide, cocoalkyl dimethylamine oxide and cocoalkyl polyglucoside with an average of 1.4 glucose units. In addition, it is also possible to use end group-capped C₈-C₁₈-alkyl alcohol polyglycol ethers, i.e. compounds in which the usually free OH group of the C₈-C₁₈-alkyl alcohol polyglycol ethers has been etherified. As further nonionic surfactants, nitrogen-containing surfactants may be present, for example fatty acid polyhydroxy amides, for example glucamides, and ethoxylates of alkylamines, vicinal diols and/or carboxamides which have alkyl groups having from 10 to 22 carbon atoms, preferably from 12 to 18 carbon atoms. The degree of ethoxylation of these compounds is generally between 1 and 20, preferably between 3 and 10. Preference is given to ethanolamide derivatives of alkanoic acids having from 8 to 22 carbon atoms, preferably from 12 to 16 carbon atoms.

In a preferred embodiment, the inventive composition is, however, free of alkoxylated non ionic surfactants.

In addition to the surfactant types mentioned so far, the inventive composition may additionally also comprise cationic surfactants and/or amphoteric surfactants.

Suitable amphosurfactants are, for example, betaines of the formula (Rⁱⁱⁱ)(R^{iv})(R^{v})N⁺CH₂COO⁻ in which Rⁱⁱⁱ is an alkyl radical which is optionally interrupted by heteroatoms or heteroatom groups and has from 8 to 25, preferably from 10 to 21 carbon atoms, and R^{iv} and R^{v} are identical or different alkyl radicals having from 1 to 3 carbon atoms, especially C₁₀-C₁₈-alkyldimethylcarboxymethylbetaine and C₁₁-C₁₇-alkylamidopropyldimethylcarboxymethylbetaine. The compositions contain amphoteric surfactants in amounts, based on the composition, of from 0 to 10% by weight.

Suitable cationic surfactants include the quaternary ammonium compounds of the formula (R^{vi})(R^{vii})(R^{viii})(R^{ix})N⁺X⁻ in which R^{vi} to R^{ix} are four identical or different, especially two long-chain and two short-chain, alkyl radicals, and X⁻ is an anion, especially a halide ion, for example didecyidimethylammonium chloride, alkylbenzyldidecylammonium chloride and mixtures thereof. The compositions comprise cationic surfactants in amounts, based on the composition, of from 0 to 10% by weight.

In a particularly preferred embodiment, however, apart from C₈-C₁₈-alkyl sulfates and/or fatty acid sarcosinates, the composition does not comprise any further surfactant components.

### Viscosity

The composition preferably has a Brookfield viscosity (model DV-II+, spindle 31, rotation frequency 20 min⁻¹, 20° C.) of from 0.1 to 200 mPa·s, especially from 0.5 to 100 mPa·s, exceptionally preferably from 1 to 60 mPa·s. For this purpose, the composition may comprise viscosity regulators. The amount of viscosity regulator is typically up to 0.5% by weight, preferably from 0.001 to 0.3% by weight, especially from 0.01 to 0.2% by weight, exceptionally preferably from 0.01 to 0.15% by weight.

### Viscosity Regulators

Suitable viscosity regulators are, for example, organic natural thickeners (agar-agar, carrageenan, tragacanth, gum arabic, alginates, pectins, polyoses, guar flour, locust bean gum, starch, dextrins, gelatins, casein), organically modified natural substances (carboxymethylcellulose and other cellulose ethers, hydroxyethyl- and -propylcellulose and the like, seed flour ethers), organic fully synthetic thickeners (polyacrylic and polymethacrylic compounds, vinyl polymers, polycarboxylic acids, polyethers, polyimines, polyamides) and inorganic thickeners (polysilicic acids, clay minerals such as montmorillonites, zeolites, silicas).

The polyacrylic and polymethacrylic compounds include, for example, the high molecular weight homopolymers of acrylic acid crosslinked with a polyalkenyl polyether, especially an allyl ether of sucrose, pentaerythritol or propylene (INCI designation according to International Dictionary of Cosmetic Ingredients of the Cosmetic, Toiletry, and Fragrance Association (CTFA): Carbomer) which are also referred to as carboxyvinyl polymers. Such polyacrylic acids are obtainable, inter alia, from 3V Sigma under the trade name Polygel®, e.g. Polygel® DA, and from BFGoodrch under the trade name Carbopol®, e.g. Carbopol® 940 (molecular weight approx. 4 000 000), Carbopol® 941 (molecular weight approx. 1 250 000) or Carbopol® 934 (molecular weight approx. 3 000 000). This also includes the following acrylic acid copolymers: (i) copolymers of two or more monomers from the group of acrylic acid, methacrylic acid and their monoesters preferably formed with C₁₋₄-alkanols (INCI Acrylates Copolymer), which include, for instance, the copolymers of methacrylic acid, butyl acrylate and methyl methacrylate (CAS designation according to Chemical Abstracts Service: 25035-69-2) or of butyl acrylate and methyl methacrylate (CAS 25852-37-3) and which are obtainable, for example, from Rohm & Haas under the trade names Aculyn® and Acusol®, and from Degussa (Goldschmidt) under the trade name Tego® Polymer, for example the anionic nonassociative polymers Aculyn® 22, Aculyn® 28, Aculyn® 33 (crosslinked), Acusol® 810, Acusol® 823 and Acusol® 830 (CAS 25852-37-3); (ii) crosslinked high molecular weight acrylic acid copolymers, which include, for instance, the copolymers of C₁₀₋₃₀-alkyl acrylates with one or more monomers from the group of acrylic acid, methacrylic acid and their monoesters preferably formed with C₁₋₄-alkanols, which have been crosslinked with an allyl ether of sucrose or of pentaerythritol (INCI Acrylates/C₁₀₋₃₀ Alkyl Acrylate Crosspolymer), and which are obtainable, for example, from BFGoodrich under the trade name Carbopol®, for example the hydrophobized Carbopol® ETD 2623 and Carbopol® 1382 (INCI Acrylates/C10-30 Alkyl Acrylate Crosspolymer), and also Carbopol® AQUA 30 (formerly Carbopol® EX473).

Further thickeners are the polysaccharides and heteropolysaccharides, especially the polysaccharide gums, for example gum arabic, agar, alginates, carrageenans and salts thereof, guar, guaran, tragacanth, gellan, ramsan, dextran or xanthan, and derivatives thereof, for example propoxylated guar, and mixtures thereof. Other polysaccharide thickeners, such as starches or cellulose derivatives, can be used alternatively, but preferably additionally to a polysaccharide gum, for example starches of a wide variety of different origins and starch derivatives, for example hydroxyethyl starch, starch phosphate esters or starch acetates, or carboxymethylcellulose or its sodium salt, methyl-, ethyl-, hydroxyethyl-, hydroxypropyl-, hydroxypropylmethyl- or hydroxyethylmethylcellulose or cellulose acetate. A particularly preferred polysaccharide thickener is the microbial anionic heteropolysaccharide xanthan gum, which is produced by Xanthomonas campestris and a few other species under aerobic conditions with a molecular weight of 2-15×10⁶ and is obtainable, for example, from Kelco under the trade names Keltrol® and Kelzan®, or else from Rhodia under the trade name Rhodopol®.

The thickeners used may also be sheet silicates. These include, for example, the magnesium or sodium-magnesium sheet silicates from Solvay Alkali obtainable under the trade name Laponite®, especially Laponite® RD or else Laponite® RDS, and also the magnesium silicates from Süd-Chemie, in particular Optigel® SH.

In the selection of the suitable viscosity regulator, it should be ensured that the transparent appearance of the cleaning composition is maintained, i.e. the use of the thickener should not lead to cloudiness of the composition.

Viscosity regulators can be used especially in inventive cleaning compositions which are formulated as all-purpose cleaners. Inventive glass cleaners, in contrast, are free of such additives in a particularly preferred embodiment.

### Further Ingredients

In addition to the components mentioned, the inventive compositions may comprise further assistants and additives, as are customary in such compositions. These include especially dyes, fragrances (perfume oils), antistats, preservatives, corrosion inhibitors, complexing agents for alkaline earth metal ions, enzymes, bleach systems, disinfectants, UV absorbers, electrolyte salts and UV stabilizers. The amount of such additives is typically not more than 2% by weight in the cleaning composition. The lower limit of their use depends on the type of additive and may, for example, in the case of dyes be up to 0.001% by weight and lower. The amount of assistants is preferably between 0.01 and 1% by weight.

The water content of the inventive aqueous composition is typically at least 90% by weight, preferably at least 95% by weight.

The pH of the inventive composition can be varied over a wide range, but preference is given to a range of from 2.5 to 12. Glass cleaner formulations and all-purpose cleaners have especially a pH of from 6 to 11, especially preferably from 7 to 10.5, and bathroom cleaners especially a pH of from 2 to 5, exceptionally preferably from 2.5 to 4.0.

The inventive compositions are preferably formulated in ready-to-use form. A formulation as a concentrate to be diluted appropriately before use is likewise possible in the context of the inventive teaching, in which case the ingredients are present in the upper region of the ranges specified in each case.

The inventive compositions can be prepared by mixing directly from their raw materials, subsequent thorough mixing and final standing of the composition until it is free from bubbles.

For use, the inventive composition should be applied to the surface to be cleaned in the form of a foam. For this purpose, a manually activated spray dispenser is particularly suitable, especially selected from the group comprising aerosol spray dispensers, self-pressurizing spray dispensers, pump spray dispensers and trigger spray dispensers, especially pump spray dispensers and trigger spray dispensers with a container made of polyethylene, polypropylene or polyethylene terephthalate. Such trigger bottles are supplied, for example, by Afa-Polytec. The spray head is preferably equipped with a foam nozzle. In addition, it is also possible to use pump foam dispensers, as supplied, for example, by Airspray, Keltec, Taplast or else Daiwa Can Company.

The invention accordingly further provides a product composed of an inventive aqueous cleaning composition and a spray dispenser, especially of an inventive aqueous cleaning composition and of a trigger bottle with a foam nozzle.

The inventive compositions are preferably used for glass cleaning, both for windows and for mirrors and other glasses. However, they may also serve to clean hard surfaces, in particular in the case of shiny surfaces, in which residue-free removal of the cleaning composition with simultaneously good cleaning performance is likewise highly desirable. Hard surfaces in the context of this application are therefore not only windows and mirrors and also further glass surfaces, but also, for example, surfaces of ceramic, plastic, metal or else (especially varnished) wood which are found in the household and commerce, for example bathroom ceramic, kitchen surfaces or floors.

The invention therefore thirdly provides for the use of an inventive aqueous cleaning composition or of an inventive product for cleaning hard surfaces, especially glass.

For the cleaning of hard surfaces with the inventive composition, the following process has been found to be useful, which accordingly constitutes the fourth subject of the invention: the inventive aqueous cleaning composition is applied to the surface to be cleaned with a spray dispenser (trigger bottle) with a foam nozzle, and the foam, optionally after an action time of up to 5 minutes, is rubbed on the surface with a sponge, cloth, leather or another utensil typically used for cleaning purposes, in the course of which the foam decomposes and is absorbed together with the soil detached, such that no significant residue remains on the clean surface.

### WORKING EXAMPLES

Inventive glass cleaners E1 to E4 and the comparative formulations C1 to C3 not encompassed by the subject-matter of this application were prepared, whose composition can be taken from the table below. All amounts are specified in % by weight of the active substance based on the overall composition.

TABLE 1
Illustrative compositions

| | E1 | E2 | E3 | E4 | C1 | C2 | C3 |
|---|---|---|---|---|---|---|---|
| Laurylsulfate-monoethanolamine¹ | 0.03 | 0.03 | — | | — | — | — |
| Laurylsulfate-sodium² | — | — | 0.03 | | — | — | — |
| Sodium cocoylsarcosinate³ | — | — | — | 0.015 | — | — | — |
| C₈₋₁₀-alkylpolyglycoside⁴ | — | — | — | — | 0.03 | — | — |
| C₁₂₋₁₄-fatty alcohol ethoxylate- | — | — | — | — | — | 0.03 | — |
| 4EO⁵ | | | | | | | |
| Fatty alcohol ether sulfate⁶ | — | — | — | — | — | — | 0.03 |
| Isopropanol | 1 | 1 | 1 | 1 | 1 | 1 | 1 |
| Butylglycol | 2.5 | 2.5 | 2.5 | 2.5 | 2.5 | 2.5 | 2.5 |
| Diethylene glycol | — | 0.05 | 0.05 | 0.05 | 0.05 | 0.05 | 0.05 |
| Ammonia | — | 0.1 | — | 0.1 | — | — | — |
| Colloidal silica sol⁷ | — | 0.06 | 0.06 | 0.06 | 0.06 | 0.06 | 0.06 |
| Perfume | — | — | — | 0.06 | — | — | — |
| Water | ad 100 | ad 100 | ad 100 | ad 100 | ad 100 | ad 100 | ad 100 |

¹Texapon ® MLS, Cognis
²Texapon ® LS 35, Cognis
³Perlastan ® C-30, Schill & Seilacher
⁴APG 220, Cognis
⁵Dehydol ® LS 4, Cognis
⁶Texapon ® NSO, Cognis
⁷Bindzil ® 30/360, Akzo Nobel/Eka Chemicals

The inventive compositions and the comparative formulations were tested for their runoff rate and their residue behavior.

To determine the runoff rate, the particular composition was applied to a vertical surface with one stroke of the trigger bottle from Afa Polytec from a distance of 10 cm, and the time taken for the foam formed to slide down by 20 cm was measured. In each case three measurements were carried out and the mean was determined.

To determine the residue formation, in each case one stroke from the trigger bottle was spread on a mirror of size 30 cm×60 cm with a folded nonwoven wipe of total size 20 cm×20 cm (Chicopee, Duralace 60) and polished in the usual way. Subsequently, the mirror was subjected to a visual test. When the composition was rubbed, it was simultaneously determined whether the foam decomposes without sound or with a crackling noise.

The results from these tests are reproduced in the table below:

TABLE 2
Runoff rate and residue behavior

| | E1 | E2 | E3 | E4 | C1 | C2 | C3 |
|---|---|---|---|---|---|---|---|
| Runoff rate 1 stroke/20 cm | 33 sec | 35 sec | 22 sec | 35 sec | 30 sec | 11 sec | 33 sec |
| Residue formation | very low | low | low | very low | smears | smears | smears |
| Crackling | loud | yes | loud | yes | yes | no | yes |

These results reveal that the inventive compositions all have a stable foam with a correspondingly satisfactory runoff rate, but can simultaneously be removed without significant residue formation, a slight crackling noise simultaneously being acoustically perceptible. Comparative compositions C1 and C3 likewise had stable foams and still crackled in the course of decomposition, but left behind significant residues in the form of a streaky film when rubbed, just like C2 which runs off rapidly and does not crackle.

1. An aqueous cleaning composition for hard surfaces which is applied to the surface to be cleaned in the form of a foam by means of a spray dispenser, characterized in that it comprises a fatty alcohol sulfate and/or a fatty acid sarcosinate, and also isopropanol and butylglycol.

2. The aqueous cleaning composition as claimed in claim 1, characterized in that the decomposition of the foam is acoustically perceptible in the form of a crackling noise.

3. The aqueous cleaning composition as claimed in either of claims 1 and 2, characterized in that it is free of alkoxylated nonionic surfactants.

4. The aqueous cleaning composition as claimed in any one of claims 1 to 3, characterized in that it contains from 0.01 to 1% by weight, preferably from 0.02 to 0.5% by weight, of fatty alcohol sulfate.

5. The aqueous cleaning composition as claimed in any one of claims 1 to 4, characterized in that it contains from 0.01 to 0.5% by weight of fatty acid sarcosinate.

6. The aqueous cleaning composition as claimed in any one of claims 1 to 5, characterized in that it comprises one or more further organic solvents.

7. The aqueous cleaning composition as claimed in claim 6, characterized in that the further organic solvent(s) is/are preferably selected from the group comprising C₁₋₆ alcohols, C₂₋₆ diols and mixtures thereof, and especially selected from the group comprising ethanol, n-butanol, ethylene glycol, diethylene glycol, propylene glycol and mixtures thereof.

8. The aqueous cleaning composition as claimed in any one of the preceding claims, characterized in that it contains from 0.01 to 0.5% by weight, preferably from 0.025 to 0.1% by weight, of diethylene glycol.

9. The aqueous cleaning composition as claimed in any one of the preceding claims, characterized in that it contains from 0.01 to 5% by weight, preferably from 0.1 to 3% by weight, of isopropanol.

10. The aqueous cleaning composition as claimed in any one of the preceding claims, characterized in that it contains from 0.1 to 6% by weight, preferably from 1 to 5% by weight, of butylglycol.

11. The aqueous cleaning composition as claimed in any one of the preceding claims, characterized in that it further comprises a colloidal silica sol, preferably in amounts of from 0.01 to 0.6% by weight.

12. The aqueous cleaning composition as claimed in any one of the preceding claims, characterized in that it comprises ammonia, preferably in amounts of from 0.01 to 0.5% by weight.

13. The aqueous cleaning composition as claimed in any one of the preceding claims, characterized in that it further comprises assistants and additives typically usable in cleaning compositions for hard surfaces, preferably those selected from the group comprising compositions for modifying or hydrophilizing surfaces, volatile alkali, acids, bases, thickeners, dyes, fragrances, antistats, preservatives, corrosion inhibitors, complexing agents for alkaline earth metal ions, enzymes, bleach systems, disinfectants, UV absorbers, electrolyte salts and UV stabilizers, and mixtures thereof.

14. A product composed of an aqueous cleaning composition as claimed in any one of the preceding claims and a spray dispenser, especially of an aqueous cleaning composition as claimed in any one of the preceding claims and of a trigger bottle with a foam nozzle.

15. The use of an aqueous cleaning composition or of a product as claimed in any one of the preceding claims for cleaning hard surfaces, especially glass.

16. A process for streak-free cleaning of hard surfaces, especially glass, characterized in that an aqueous cleaning composition as claimed in any one of claims 1 to 13 is applied to the surface to be cleaned with a spray dispenser with a foam nozzle, and the foam, optionally after an action time of up to 5 minutes, is rubbed on the surface with a sponge, cloth, leather or another utensil typically used for cleaning purposes, in the course of which the foam decomposes and is absorbed together with the soil detached, such that no significant residue remains on the clean surface.
